(19) United States
(12) Patent Application Publication
(10) Pub. No.: US 2011/0274828 A1
(43) Pub. Date: Nov. 10, 2011

(54) ELECTRODE MANUFACTURING APPARATUS AND ELECTRODE MANUFACTURING METHOD

(76) Inventor: Shigetaka Nagamatsu, Aichi-ken (JP)

(21) Appl. No.: 13/145,810

(22) PCT Filed: Feb. 8, 2010
(86) PCT No.: PCT/IB2010/000241

§ 371 Date: Jul. 22, 2011

(30) Foreign Application Priority Data
Feb. 9, 2009 (JP) 2009-027300

(51) Int. Cl. B05C 13/02; B05D 3/00; B05D 5/00; B05C 9/12; B05C 5/02

(52) U.S. Cl. 427/58; 118/58

(57) ABSTRACT

An electrode manufacturing apparatus (100) is provided with an unwinding unit (10), a first oven end unit (20), a drying oven (30), a second oven end unit (80), and a winding unit (90). The first oven end unit (20) is provided with a first coating unit (27) that coats a first side of an electrode foil (2) and a second coating unit (28) that coats a second side of the electrode foil (2). The electrode manufacturing apparatus (100) is further provided with turn-back roller pairs (25), (26), (85), (86) that invert an advancement direction of the electrode foil and displace a width direction position of the electrode foil by turning the electrode foil back at an angle. As a result, the coated electrode foil (2) reciprocates through the interior of the drying oven (30) at least one and a half times.

### BACKGROUND OF THE INVENTION

1. Field of the Invention

The invention relates to an electrode manufacturing apparatus and an electrode manufacturing method for manufacturing a secondary battery electrode, and more particularly to an electrode manufacturing apparatus and an electrode manufacturing method with which an oven length of a drying oven can be shortened.

2. Description of the Related Art

An electrode in which an electrode foil is coated with an active material may be used as an electrode for a secondary battery, such as a lithium ion secondary battery. To manufacture this type of electrode, a roll of electrode foil is coated with a coating material obtained by mixing an active material and a binder, whereupon the coating layer is dried. For this purpose, the coated electrode foil is typically dried while being conveyed through a drying oven.

When the electrode foil is dried rapidly, convection or air bubbles may be generated in the coating material in the interior of the coating layer in a film thickness direction. As a result, binder existing on the electrode foil side of the coating material may migrate to the vicinity of the coating layer surface. The binder is used to bind the active material layer to the electrode foil, and therefore, when migration occurs, the binder becomes unevenly distributed toward the coating layer surface of the dried coating layer. As a result, a binder deficiency occurs near a boundary of the electrode foil and the coating layer within the interior of the coating layer.

When a battery employing this electrode is used, peeling is likely to occur on the boundary between the electrode foil and the coating layer. The reason for this is that peel resistant in the vicinity of the boundary is low due to the binder deficiency. Meanwhile, in the interior of the coating layer, the volume of the active material repeatedly varies due to ion occlusion/emission during use of the battery. Peeling of the active material layer is caused by both the reduction in peel strength and the variation in the volume of the active material. A chemical reaction does not occur on the surface of the peeled active material, and therefore the performance of the battery deteriorates. Hence, drying must be performed under favorable drying conditions to secure a favorable battery performance. In other words, a sufficient drying time must be secured to ensure that the drying is performed gradually.

Meanwhile, when a roller contacts the wet coating layer as the electrode foil is conveyed, the coating material adheres to the roller. Therefore, the coated electrode foil must be conveyed such that an opposite side to the wet coating layer contacts the roller. Accordingly, the electrode foil is often conveyed through the drying oven in a single direction (see FIG. 1 of Japanese Patent Application Publication No. 2007-141540 (JP-A-2007-141540)). In this case, a length of the drying oven and a length of a conveyance path of the electrode foil through the drying oven are substantially identical.

Therefore, to convey the electrode foil while securing a sufficient drying time, a drying oven having a great overall oven length must be used. With a drying oven having a great oven length, disposal locations are limited. Moreover, a large drying oven has a large volume and a large surface area, and is therefore thermally inefficient. Furthermore, when double-sided coating is performed, an even larger drying oven is required.

### SUMMARY OF THE INVENTION

The invention provides an electrode manufacturing apparatus and an electrode manufacturing method with which reductions in the length, volume, and surface area of an oven can be achieved, enabling an improvement in thermal efficiency, and with which drying can be performed slowly.

A first aspect of the invention relates to an electrode manufacturing apparatus. The electrode manufacturing apparatus includes: a coating unit that applies a coating material to a strip-form electrode foil; a drying unit that dries a coating layer while conveying the electrode foil coated by the coating unit in a lengthwise direction thereof; and at least two inversion units that invert an advancement direction of the electrode foil by contacting an opposite side of the electrode foil to the coating layer dried by the drying unit. The inversion units not only invert the advancement direction of the electrode foil, but also displace a width direction position thereof by turning the electrode foil back such that the electrode foil is angled in a width direction thereof. The drying unit dries the coating layer while the electrode foil reciprocates at least one and a half times as a result of inversion of the advancement direction of the electrode foil by the inversion units.

With the electrode manufacturing apparatus according to the aspect described above, the electrode foil reciprocates through the drying oven while being inverted, and therefore the coating layer can be dried over a sufficient drying period. Moreover, the size of the drying oven is reduced, leading to improved thermal efficiency.

In the aspect described above, the coating unit may include a first coating unit that coats a first side of the electrode foil and a second coating unit that coats a second side of the electrode foil, and the drying unit may include a first drying unit that dries the coating layer applied by the first coating unit and a second drying unit that dries the coating layer applied by the second coating unit. The second coating unit may coat the electrode foil following drying by the first drying unit. At least two of the inversion units may be provided respectively in the first drying unit and the second drying unit.

According to the aspect described above, the electrode manufacturing apparatus coats both sides of the electrode foil, and therefore the coating layers can be dried over an even more sufficient drying period.

In the aspect described above, the first coating unit and the second coating unit may be provided on an identical side relative to a reciprocating motion of the electrode through the first drying unit.

According to the aspect described above, the electrode manufacturing apparatus exhibits superior operating efficiency.

In the aspect described above, the first coating unit and the second coating unit may be provided on opposite sides relative to a reciprocating motion of the electrode through the first drying unit.

In the aspect described above, the first coating unit may include a first side coating die and a first side coating backup roller, and the second coating unit may include a second side coating die and a second side coating backup roller.

In the aspect described above, a gap between the second side coating die and the second side coating backup roller may be larger than a gap between the first side coating die and the first side coating backup roller by a thickness of the coating material applied to the first side.

In the aspect described above, from a point at which the first coating unit finishes applying the coating material to the first side to a point at which the second coating unit applies the coating material to the second side, the electrode may be conveyed such that the inversion units contact only the second side, and from a point at which the second coating unit finishes applying the coating material to the second side, the electrode may be conveyed such that the inversion units contact only the first side.

In the aspect described above, the second coating unit may apply the coating material to the second side after the first drying unit finishes drying the first side.

In the aspect described above, the inversion units may invert the advancement direction of the electrode such that the electrode does not contact the respective inversion units while undergoing a different process.

In the aspect described above, the inversion units may respectively be constituted by a set of two rollers, and the angle may be modified by tilting a central axis of one of the rollers of the inversion unit such that the central axis is inclined in a horizontal plane relative to a central axis of the other roller.

A second aspect of the invention relates to an electrode manufacturing method. The electrode manufacturing method includes applying a coating material to a strip-form electrode foil and then drying a coating layer while conveying the electrode foil in a lengthwise direction. The coating layer is dried while an advancement direction of the electrode foil is modified at least twice such that the electrode foil reciprocates at least one and a half times as a result of inverting the advancement direction of the electrode foil while displacing a width direction position of the electrode foil during the drying by turning the electrode foil back such that the electrode foil is angled in a width direction thereof.

With the electrode manufacturing method according to the aspect described above, the coating layer can be dried over an even more sufficient drying period, and therefore the coating layer can be dried gradually.

According to the aspects described above, an electrode manufacturing apparatus and an electrode manufacturing method with which reductions in the length, volume, and surface area of an oven can be reduced, leading to an improvement in thermal efficiency, and with which drying can be performed slowly, are obtained.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a sectional view showing a width direction cross-section of a single-coated electrode manufactured by an electrode manufacturing apparatus according to the invention;

FIG. 2 is a projected view illustrating the electrode manufacturing apparatus according to the invention from a front surface;

FIG. 3 is a projected view illustrating a first electrode conveyance section in the electrode manufacturing apparatus according to the invention from above;

FIG. 4 is a projected view illustrating a second electrode conveyance section in the electrode manufacturing apparatus according to the invention from above;

FIG. 5 is a projected view illustrating a third electrode conveyance section in the electrode manufacturing apparatus according to the invention from above;

FIG. 6 is a projected view illustrating a fourth electrode conveyance section in the electrode manufacturing apparatus according to the invention from above;

FIG. 7 is a sectional view showing a width direction cross-section of a triple-coated electrode manufactured by the electrode manufacturing apparatus according to the invention;

FIG. 8 is a view illustrating a different disposal example of a coating device provided in the electrode manufacturing apparatus according to the invention; and

FIG. 9 is a projected view illustrating a different disposal example of a coating unit provided in the electrode manufacturing apparatus according to the invention from a front surface.

### DETAILED DESCRIPTION OF EMBODIMENTS

An embodiment of the invention will be described in detail below with reference to the drawings. In this embodiment, the invention is realized by an electrode manufacturing apparatus and an electrode manufacturing method for manufacturing a lithium ion secondary battery electrode.

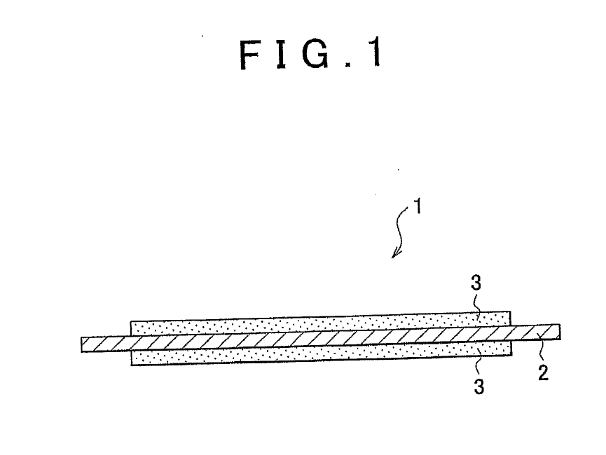

The lithium ion secondary battery electrode manufactured by the electrode manufacturing apparatus according to this embodiment will now be described. As shown by the sectional view in FIG. 1, an electrode 1 manufactured by the electrode manufacturing apparatus according to this embodiment is obtained by coating both sides of a strip-form electrode foil 2 with a coating layer 3. FIG. 1 is a sectional view showing a width direction cross-section of the electrode 1. The coating layer 3 is an active material layer formed by applying and then drying a coating material such that the coating material is bound to the electrode foil 2. The coating layer 3 is applied to the vicinity of a width direction center of the electrode foil 2 such that the two width direction ends form uncoated portions. A coating width of the coating layer 3 shown on an upper side of the drawing is identical to the coating width of the coating layer 3 shown on a lower side of the drawing. Further, a width direction position of the coating layer 3 shown on the upper side of the drawing is identical to the width direction position of the coating layer 3 shown on the lower side of the drawing. In other words, the coating layer 3 shown on the upper side of the drawing is positioned directly opposite the coating layer 3 shown on the lower side of the drawing.

The electrode 1 may be an anode or a cathode. In an anode for a lithium ion secondary battery, aluminum foil or the like may be used as the electrode foil 2. Further, the coating material used for the coating layer 3 of an anode is an anode active material such as lithium nickel oxide (LiNiO₂), lithium manganese oxide (LiMnO₂), lithium cobalt oxide (LiCoO₂), or another lithium compound oxide. In a cathode for a lithium ion secondary battery, copper foil or the like may be used as the electrode foil 2. Further, the coating material used for the coating layer 3 of a cathode is a cathode active material such as amorphous carbon, complex graphitized carbon, simple graphitized carbon, graphite, or another carbon-based material.

As described above, an anode and a cathode use different materials. However, an anode and a cathode are substantially identical in terms of the width, thickness and so on of the electrode foil 2 and the coating layer 3. Moreover, as shown in FIG. 1, the coating layer 3 is applied to both sides of the electrode foil 2 in both an anode and a cathode. Hence, the electrode manufacturing apparatus for manufacturing a secondary battery electrode according to this embodiment is capable of manufacturing both an anode and a cathode of a lithium ion secondary battery. Therefore, the electrode 1 will be described below without differentiating between an anode and a cathode.

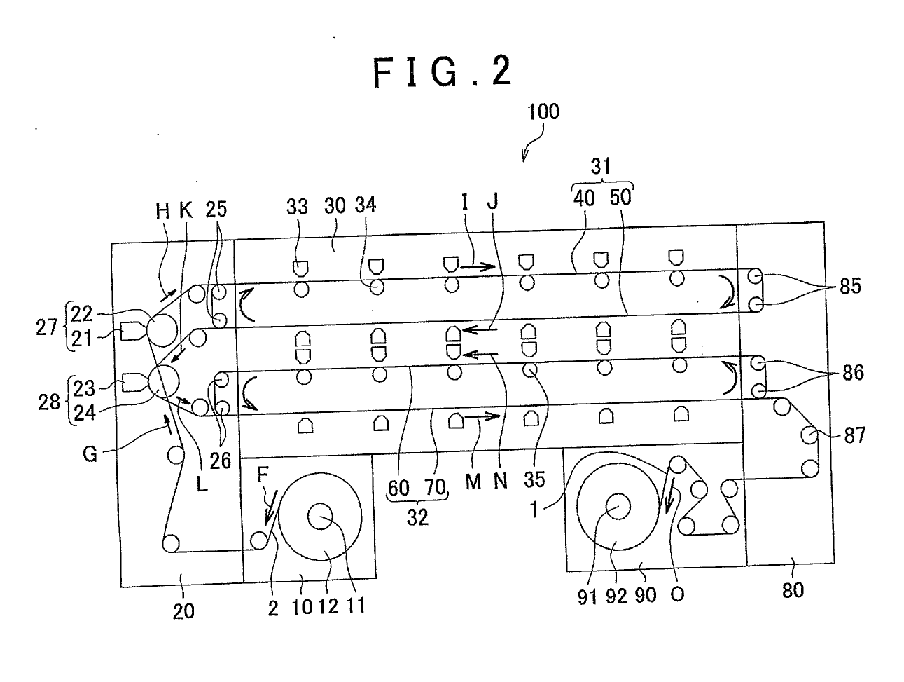

An electrode manufacturing apparatus 100 for manufacturing a lithium ion secondary battery electrode according to this embodiment manufactures the electrode 1 by coating the electrode foil 2 with a coating material to form the coating layer 3 and then drying the coating material. As shown in FIG. 2, the electrode manufacturing apparatus 100 includes an unwinding unit 10, a first oven end unit 20, a drying oven 30, a second oven end unit 80, and a winding unit 90. The unwinding unit 10 is an electrode foil supply unit that unwinds the electrode foil 2 and supplies the unwound electrode foil 2 to the first oven end unit 20. The first oven end unit 20 conveys the electrode foil 2 from the unwinding unit 10 to the drying unit 30 and turns the electrode foil 2 back during drying. The first oven end unit 20 is provided with a first coating unit 27 and a second coating unit 28 for coating the electrode foil 2. The drying oven 30 is a drying unit for drying the coating material applied to the electrode foil 2. The second oven end unit 80 turns the electrode foil 2 back during drying and gathers the dried electrode foil 2 in the winding unit 90. The winding unit 90 is an electrode collecting unit for winding the electrode 1.

As shown in FIG. 2, the unwinding unit 10 is provided with a rotary shaft 11 on which an electrode foil reel 12 is disposed, and the electrode foil reel 12 is constituted by a roll of the uncoated electrode foil 2. Therefore the electrode foil reel 12 is capable of rotating about the rotary shaft 11. Hence, the electrode foil 2 is unwound from the electrode foil reel 12 by being pulled in a lengthwise direction. Note that the electrode foil reel 12 may be replaced as appropriate, for example when the electrode foil 2 has been completely unwound. Further, two or more electrode foil reels 12 may be disposed on the unwinding unit 10. Moreover, a terminal end of the electrode foil 2 of a single electrode foil reel 12 may be connected to a front end of the electrode foil 2 of another electrode foil reel 12 so that a feeding operation of the electrode foil 2 is performed efficiently.

As shown in FIG. 2, the first oven end unit 20 includes the first coating unit 27, the second coating unit 28, and turn-back roller pairs 25, 26. The first coating unit 27 includes a first side coating die 21 and a first side coating backup roller 22. Here, the first side denotes a surface of the electrode foil 2 that is coated by the electrode manufacturing apparatus 100 first. The second coating unit 28 includes a second side coating die 23 and a second side coating backup roller 24. Here, the second side denotes an opposite surface of the electrode foil 2 to the first side, which is coated after the first side has been coated.

The first side coating die 21 is a coating liquid supply device for applying the coating material to the first side of the electrode foil 2. The first side coating backup roller 22 is a roller for supporting the electrode foil 2 while the first side is coated. The second side coating die 23 is a coating liquid supply device for applying the coating material to the second side of the electrode foil 2. The second side coating backup roller 24 is a roller for supporting the electrode foil 2 while the second side is coated.

The first side coating die 21 and second side coating die 23 are both disposed in the interior of the first oven end unit 20. Thus, the coating liquid supply devices can be replenished with the coating liquid and so on efficiently. The first side coating die 21 applies a coating material including an active material to the electrode foil 2 at a predetermined width and a predetermined thickness. Therefore, a small gap is provided between the first side coating die 21 and the first side coating backup roller 22 so that the thickness of the coating layer 3 can be reproduced. Similarly, a small gap is provided between the second side coating die 23 and the second side coating backup roller 24. Note; however, that the gap between the second side coating die 23 and the second side coating backup roller 24 is wider than the gap between the first side coating die 21 and the first side coating backup roller 22 by an amount corresponding to the thickness of the dry coating layer 3 already applied to the first side.

As shown in FIG. 2, the drying oven 30 includes an air nozzle 33, and driven rollers 34, 35. Further, a conveyance path of the drying oven 30 is constituted by four stages. The four-stage conveyance path is constituted by a first electrode conveyance section 40, a second electrode conveyance section 50, a third electrode conveyance section 60, and a fourth electrode conveyance section 70, which are disposed in that order from the top of the drawing. The first electrode conveyance section 40 conveys the electrode foil 2 from the first oven end unit 20 toward the second oven end unit 80, or in other words in the direction of an arrow I in the drawing. The second electrode conveyance section 50 conveys the electrode foil 2 from the second oven end unit 80 toward the first oven end unit 20, or in other words in the direction of an arrow J in the drawing. The third electrode conveyance section 60 conveys the electrode foil 2 from the second oven end unit 80 toward the first oven end unit 20, or in other words in the direction of an arrow N in the drawing. The fourth electrode conveyance section 70 conveys the electrode foil 2 from the first oven end unit 20 toward the second oven end unit 80, or in other words in the direction of an arrow M in the drawing. The first electrode conveyance section 40 and second electrode conveyance section 50 together constitute a first side drying unit 31 for drying the coating layer 3 on the first side of the electrode foil 2. The third electrode conveyance section 60 and fourth electrode conveyance section 70 together constitute a second side drying unit 32 for drying the coating layer 3 on the second side of the electrode foil 2.

The air nozzle 33 is a nozzle for blowing warm air onto the electrode foil 2 and the coating layer 3 as they pass through the first electrode conveyance section 40, second electrode conveyance section 50, third electrode conveyance section 60, and fourth electrode conveyance section 70. Further, the air nozzle 33 is disposed at fixed intervals along the conveyance path of the electrode foil 2 in the interior of the drying oven 30. The warm air ejected from the air nozzles 33 is distributed uniformly in the width direction. The driven rollers 34, 35 are rollers that support the electrode foil 2 in the first electrode conveyance section 40 or the third electrode conveyance section 60.

The second oven end unit 80 includes turn-back roller pairs 85, 86 and a driven roller 87. The turn-back roller pair 85 is an inversion unit for turning the electrode foil 2 back such that the electrode foil 2 is conveyed from the first electrode conveyance section 40 to the second electrode conveyance section 50. Further, the turn-back roller pair 85 forms a pair with the turn-back roller pair 25 of the first oven end unit 20. The turn-back roller pair 25 is an inversion unit for turning the electrode foil 2 back such that the electrode foil 2 is conveyed from the second electrode conveyance section 50 to the first electrode conveyance section 40. The turn-back roller pair 86 is an inversion unit for turning the electrode foil 2 back such that the electrode foil 2 is conveyed from the fourth electrode conveyance section 70 to the third electrode conveyance section 60. Further, the turn-back roller pair 86 forms a pair with the turn-back roller pair 26 of the first oven end unit 20. The turn-back roller pair 26 is an inversion unit for turning the electrode foil 2 back such that the electrode foil 2 is conveyed from the third electrode conveyance section 60 to the fourth electrode conveyance section 70. The turn-back roller pairs 25, 26, 85, 86 are respectively constituted by upper and lower rollers. When turning the electrode foil 2 back to invert an advancement direction thereof, the respective turn-back roller pairs 25, 26, 85, 86 turn the electrode foil 2 back such that the electrode foil 2 is slightly angled in the width direction. This will be described in detail below.

As shown in FIG. 2, the winding unit 90 is provided with a rotary shaft 91 on which an electrode winding reel 92 is disposed. The coated, dried electrode 1 is wound onto the electrode winding reel 92 in a roll form. The electrode winding reel 92 is driven by a power supply such as a motor. Thus, the coated electrode foil 2 can be wound onto the electrode winding reel 92. Note that the electrode winding reel 92 may be replaced as appropriate during manufacture of the electrode 1. Further, two or more electrode winding reels 92 may be provided. Moreover, a device that divides the manufactured electrodes 1 by means of slits may be provided.

The conveyance path of the electrode foil 2 through the electrode manufacturing apparatus 100 according to this embodiment will now be described using FIGS. 2 to 6. First, the four-stage conveyance path through the interior of the drying oven 30 will be described. The first electrode conveyance section 40 is a conveyance path extending from the upper side roller of the turn-back roller pair 25 to the upper side roller of the turn-back roller pair 85. The second electrode conveyance section 50 is a conveyance path extending from the lower side roller of the turn-back roller pair 25 to the lower side roller of the turn-back roller pair 85. The third electrode conveyance section 60 is a conveyance path extending from the upper side roller of the turn-back roller pair 26 to the upper side roller of the turn-back roller pair 86. The fourth electrode conveyance section 70 is a conveyance path extending from the lower side roller of the turn-back roller pair 26 to the lower side roller of the turn-back roller pair 86.

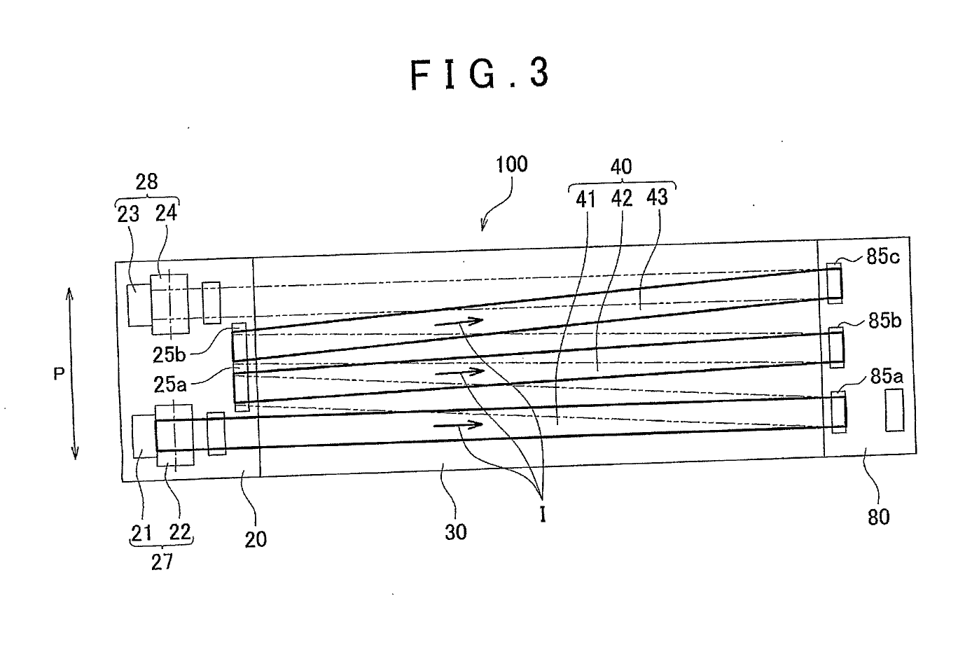

FIG. 3 shows the first electrode conveyance section 40. FIG. 3 is a projected view showing a projection of the first oven end unit 20, the first electrode conveyance section 40, and the second oven end unit 80 from the upper side of FIG. 2. Note that the second electrode conveyance section 50 is shown by dot-dot-dash lines for reference. The first coating unit 27 is disposed in the first oven end unit 20 on a lower side of FIG. 3, or in other words a near side of FIG. 2, while the second coating unit 28 is disposed in the first oven end unit 20 on an upper side of FIG. 3, or in other words a far side of FIG. 2. A turn-back roller pair 25a and a turn-back roller pair 25b are disposed in the first coating unit 27 in that order from the lower side of FIG. 3. Further, a turn-back roller pair 85a, a turn-back roller pair 85b, and a turn-back roller pair 85c are disposed in the second coating unit 28 in that order from the lower side of FIG. 3. In other words, on a plan view, the respective turn-back roller pairs 25, 85 shown in FIG. 2 are provided in pluralities.

The first electrode conveyance section 40 serves as an upper stage of the first side drying unit 31. The first side drying unit 31 is a drying section for drying the coating layer 3 on the first side of the electrode foil 2 while the electrode foil 2 is conveyed from the location of the first coating unit 27 to the location of the second coating unit 28. As shown in FIG. 3, the first electrode conveyance section 40 is constituted by conveyance paths 41, 42, 43. The conveyance paths 41, 42, 43 convey the electrode foil 2 from the first oven end unit 20 to the second oven end unit 80, or in other words in the direction of the arrow I in FIGS. 2 and 3. The conveyance path 41, the conveyance path 42, and the conveyance path 43 are positioned in sequence from the first coating unit 27 side to the second coating unit 28 side, or in other words from bottom to top in FIG. 3.

The conveyance path 41 conveys the electrode foil 2 from the first side coating backup roller 22 toward the turn-back roller pair 85a. A conveyance direction of the conveyance path 41 is perpendicular to a rotary axis of the first side coating backup roller 22. Thus, the effect of conveyance on a coating position and a coating width is minimized, and as a result, the first side can be coated favorably by the first side coating die 21. The conveyance path 42 conveys the electrode foil 2 from the turn-back roller pair 25a toward the turn-back roller pair 85b. The conveyance path 43 conveys the electrode foil 2 from the turn-back roller pair 25b toward the turn-back roller pair 85c.

Note that the turn-back roller pairs 25a, 25b, 85a, 85b, 85c not only invert the advancement direction of the electrode foil 2, but also turn the electrode foil 2 back such that the electrode foil 2 is angled in the width direction, thereby displacing the width direction position of the electrode foil 2. Here, the width direction corresponds to the width direction of the electrode foil 2, which is indicated by an arrow P in FIG. 3. The angle can be modified by tilting a central axis of the lower side roller of the turn-back roller pair 85, for example, such that the lower side roller is inclined in a horizontal plane relative to the central axis of the upper side roller. In other words, the turn-back roller pairs 25, 85 not only turn the electrode foil 2 back to invert the advancement direction thereof, but also set a direction that is angled relative to the original advancement direction as a new advancement direction. Thus, the width direction position of the electrode foil 2 shifts in the width direction from its original position during a single reciprocation through the drying oven 30.

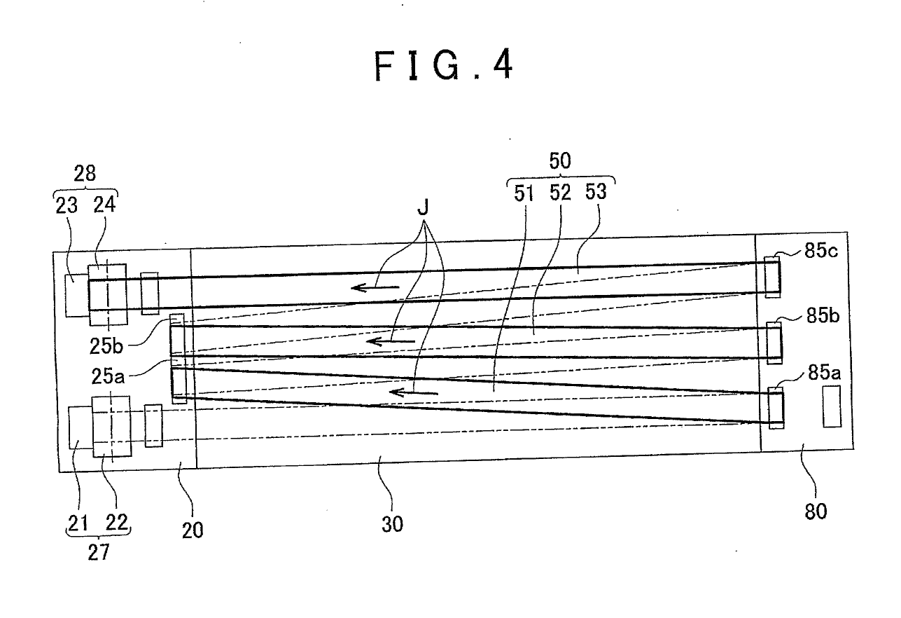

FIG. 4 shows the second electrode conveyance section 50. FIG. 4 is a projected view showing a projection of the first oven end unit 20, the second electrode conveyance section 50, and the second oven end unit 80 from the upper side of FIG. 2. Note that the first electrode conveyance section 40 is shown by dot-dot-dash lines for reference. The turn-back roller pairs 25a, 25b, 85a, 85b, 85c are disposed as shown in FIG. 3.

The second electrode conveyance section 50 serves as a lower stage of the first side drying unit 31. As shown in FIG. 4, the second electrode conveyance section 50 is constituted by conveyance paths 51, 52, 53. The conveyance paths 51, 52, 53 convey the electrode foil 2 from the second oven end unit 80 to the first oven end unit 20, or in other words in the direction of the arrow J in FIGS. 2 and 4. The conveyance path 51, the conveyance path 52, and the conveyance path 53 are positioned in sequence from the first coating unit 27 side to the second coating unit 28 side, or in other words from bottom to top in FIG. 4.

The conveyance path 51 conveys the electrode foil 2 from the turn-back roller pair 85a toward the turn-back roller pair 25a. The conveyance path 52 conveys the electrode foil 2 from the turn-back roller pair 85b toward the turn-back roller pair 25b. The conveyance path 53 conveys the electrode foil 2 from the turn-back roller pair 85c toward the second side coating backup roller 24. The conveyance direction of the conveyance path 53 is perpendicular to a rotary axis of the second side coating backup roller 24. Thus, the effect of conveyance on the coating position and coating width is minimized, and as a result, the second side can be coated favorably by the second side coating die 23.

Note that the turn-back roller pairs 25a, 25b, 85a, 85b, 85c not only invert the advancement direction of the electrode foil 2, but also turn the electrode foil 2 back such that the electrode foil 2 is angled in the width direction, thereby displacing the width direction position of the electrode foil 2.

Hence, in the electrode manufacturing apparatus 100 according to this embodiment, following coating of the first side, the electrode foil 2 is moved upward in FIG. 3 while reciprocating through the interior of the drying oven 30 along the conveyance path 41, the conveyance path 51, the conveyance path 42, the conveyance path 52, the conveyance path 43, and the conveyance path 53 in that order. In other words, the electrode foil 2 is conveyed through the first side drying unit 31 in an overall spiral shape.

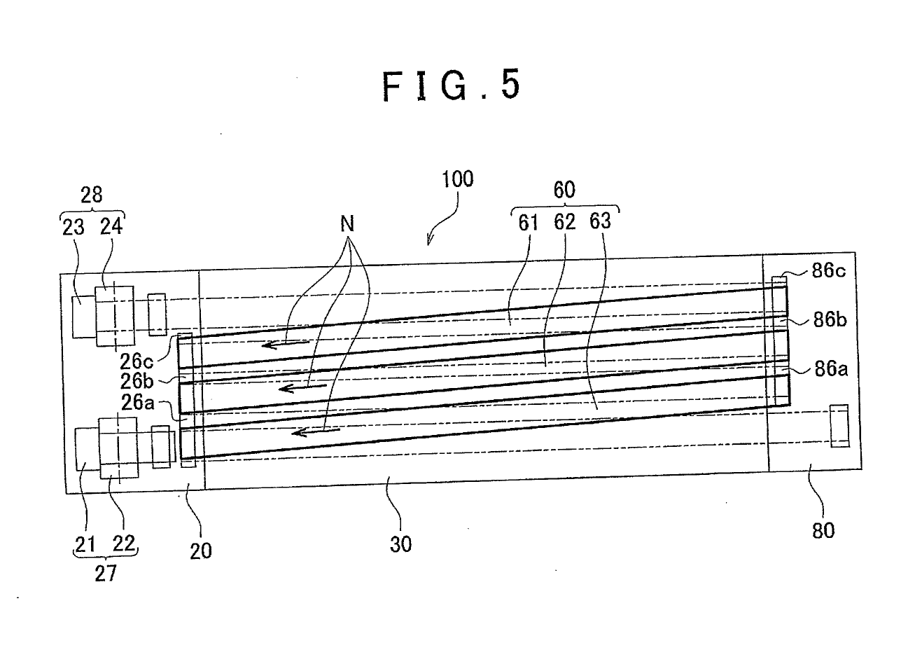

FIG. 5 shows the third electrode conveyance section 60. FIG. 5 is a projected view showing a projection of the first oven end unit 20, the third electrode conveyance section 60, and the second oven end unit 80 from the upper side of FIG. 2. Note that the fourth electrode conveyance section 70 is shown by dot-dot-dash lines for reference. The first coating unit 27 is disposed in the first oven end unit 20 on a lower side of FIG. 5, or in other words the near side of FIG. 2, while the second coating unit 28 is disposed in the first oven end unit 20 on an upper side of FIG. 5, or in other words the far side of FIG. 2. A turn-back roller pair 26a, a turn-back roller pair 26b, and a turn-back roller pair 26c are disposed in the first coating unit 27 in that order from the lower side of FIG. 5. Further, a turn-back roller pair 86a, a turn-back roller pair 86b, and a turn-back roller pair 86c are disposed in the second coating unit 28 in that order from the lower side of FIG. 5. In other words, on a plan view, the respective turn-back roller pairs 26, 86 shown in FIG. 2 are provided in pluralities.

The third electrode conveyance section 60 serves as an upper stage of the second side drying unit 32. The second side drying unit 32 is a drying section for drying the coating layer 3 on the second side of the electrode foil 2 while the electrode foil 2 is conveyed from the location of the second coating unit 28 to the winding unit 90. As shown in FIG. 5, the third electrode conveyance section 60 is constituted by conveyance paths 61, 62, 63. The conveyance paths 61, 62, 63 convey the electrode foil 2 from the second oven end unit 80 to the first oven end unit 20, or in other words in the direction of the arrow N in FIGS. 2 and 5. The conveyance path 61, the conveyance path 62, and the conveyance path 63 are positioned in sequence from the second coating unit 28 side to the first coating unit 27 side, or in other words from top to bottom in FIG. 5.

The conveyance path 61 conveys the electrode foil 2 from the turn-back roller pair 86c toward the turn-back roller pair 26c. The conveyance path 62 conveys the electrode foil 2 from the turn-back roller pair 86b toward the turn-back roller pair 26b. The conveyance path 63 conveys the electrode foil 2 from the turn-back roller pair 86a toward the turn-back roller pair 26a. Note that the turn-back roller pairs 26a, 26b, 26c, 86a, 86b, 86c not only invert the advancement direction of the electrode foil 2, but also turn the electrode foil 2 back such that the electrode foil 2 is angled in the width direction, thereby displacing the width direction position of the electrode foil 2.

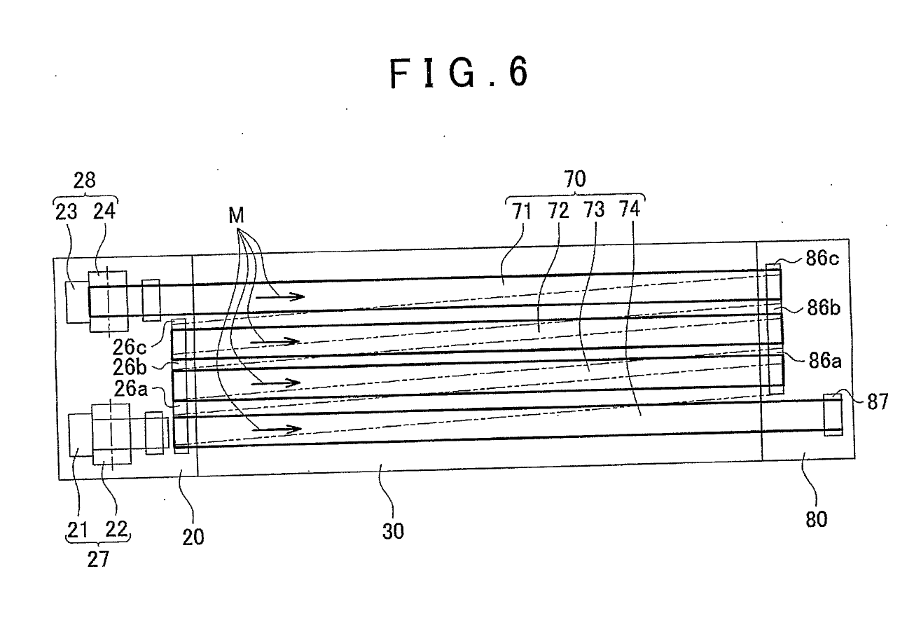

FIG. 6 shows the fourth electrode conveyance section 70. FIG. 6 is a projected view showing a projection of the first oven end unit 20, the fourth electrode conveyance section 70, and the second oven end unit 80 from the upper side of FIG. 2. Note that the third electrode conveyance section 60 is shown by dot-dot-dash lines for reference. The turn-back roller pairs 26a, 26b, 26c, 86a, 86b, 86c are disposed as shown in FIG. 5.

The fourth electrode conveyance section 70 serves as a lower stage of the second side drying unit 32. As shown in FIG. 6, the fourth electrode conveyance section 70 is constituted by conveyance paths 71, 72, 73, 74. The conveyance paths 71, 72, 73, 74 convey the electrode foil 2 from the first oven end unit 20 to the second oven end unit 80, or in other words in the direction of the arrow M in FIGS. 2 and 6. The conveyance path 71, the conveyance path 72, the conveyance path 73, and the conveyance path 74 are positioned in sequence from the second coating unit 28 side to the first coating unit 27 side, or in other words from top to bottom in FIG. 6.

The conveyance path 71 conveys the electrode foil 2 from the second side coating backup roller 24 toward the turn-back roller pair 86c. The conveyance direction of the conveyance path 71 is perpendicular to the rotary axis of the second side coating backup roller 24. Thus, the effect of conveyance on the coating position and coating width is minimized, and as a result, the second side can be coated favorably by the second side coating die 23. The conveyance path 72 conveys the electrode foil 2 from the turn-back roller pair 26c toward the turn-back roller pair 86b. The conveyance path 73 conveys the electrode foil 2 from the turn-back roller pair 26b toward the turn-back roller pair 86a. The conveyance path 74 conveys the electrode foil 2 from the turn-back roller pair 26a toward the driven roller 87.

Note that the turn-back roller pairs 26a, 26b, 26c, 86a, 86b, 86c not only invert the advancement direction of the electrode foil 2, but also turn the electrode foil 2 back such that the electrode foil 2 is angled in the width direction, thereby displacing the width direction position of the electrode foil 2. Further, the conveyance path 74 is provided to convey the dried electrode 1 to the winding unit 90 disposed on the right side of FIG. 2.

Hence, in the electrode manufacturing apparatus 100 according to this embodiment, following coating of the second side, the electrode foil 2 is moved downward in FIG. 5 while reciprocating through the interior of the drying oven 30 along the conveyance path 71, the conveyance path 61, the conveyance path 72, the conveyance path 62, the conveyance path 73, the conveyance path 63, and the conveyance path 74 in that order. In other words, the electrode foil 2 is conveyed through the second side drying unit 32 in an overall spiral shape.

Next, the conveyance path will be described in accordance with the journey of the electrode foil 2. As shown in FIG. 2, the electrode foil 2 is unwound from the electrode foil reel 12 of the unwinding unit 10 in the direction of an arrow F in the drawing. Next, the electrode foil 2 is conveyed to the first oven end unit 20. The electrode foil 2 then passes a location in which the first side coating die 21 and the first side coating backup roller 22 face each other in the direction of an arrow G. At this time, the second side of the electrode foil 2 contacts the first side coating backup roller 22. Meanwhile, the first side faces the first side coating die 21 side. Hence, the first side of the electrode foil 2 is coated.

The electrode foil 2 is then conveyed into the drying oven 30 in the direction of an arrow H. At this time, the coated first side of the electrode foil 2 faces the upper side of FIG. 2, whereas the uncoated second side of the electrode foil 2 faces the lower side of FIG. 2. Accordingly, the uncoated second side of the electrode foil 2 contacts the driven roller 34 for assisting conveyance of the electrode foil 2. At this time, the coating layer 3 is dried while facing an outer side of the spiral conveyance path.

Next, the electrode foil 2 is conveyed in the direction of the arrow I in FIG. 2, or in other words through the first electrode conveyance section 40 from the first oven end unit 20 to the second oven end unit 80. At this time, as shown in FIG. 3, the electrode foil 2 travels along the conveyance path 41 of the first electrode conveyance section 40.

Next, the electrode foil 2 reaches the location of the turn-back roller pair 85. At this time, the coated first side of the electrode foil 2 faces the upper side of FIG. 2, whereas the uncoated second side of the electrode foil 2 faces the lower side of FIG. 2. Accordingly, the uncoated second side of the electrode foil 2 contacts the turn-back roller pair 85. The advancement direction of the electrode foil 2 is then inverted by the turn-back roller pair 85 such that the electrode foil 2 is angled in the width direction.

As a result, as shown in FIG. 4, the electrode foil 2 then travels along the conveyance path 51 of the second electrode conveyance section 50 in the direction of the arrow J in the drawing. Next, the advancement direction of the electrode foil 2 is inverted again by the turn-back roller pair 25. The electrode foil 2 then travels along the conveyance path 42 shown in FIG. 3 in the direction of the arrow I in the drawing.

The electrode foil 2 is then conveyed along the conveyance path 52 in FIG. 4, the conveyance path 43 in FIG. 3, and the conveyance path 53 in FIG. 4 in that order. In other words, the coated electrode foil 2 is conveyed through the first side drying unit 31 in a spiral shape while being turned back by the turn-back roller pairs 25, 85 so as to reciprocate through the interior of the drying oven 30. During conveyance, the first side of the electrode foil 2 faces the outer side of the spiral, and therefore the coating layer 3 on the first side does not contact rollers such as the driven roller 34 and the turn-back roller pairs 25, 85.

Hence, the electrode foil 2 coated on the first side reciprocates through the interior of the drying oven 30 while the advancement direction thereof is switched by the turn-back rollers. The conveyance path is constituted such that the electrode foil 2 is conveyed in a spiral shape so as to move further upward in FIGS. 3 and 4 every time it reciprocates. Furthermore, the wet first side faces the outer side of the spiral at this time, and therefore the coating layer 3 on the first side does not contact any rollers.

After traveling along the conveyance path 53, the electrode foil 2 is conveyed back to the first oven end unit 20. At this time, the coating layer 3 on the first side of the electrode foil 2 is sufficiently dry. The electrode foil 2 is then conveyed in the direction of an arrow K in FIG. 2 to the location of the second side coating die 23. At this time, the dry coating layer 3 of the electrode foil 2 contacts the second side coating backup roller 24. However, since the coating layer 3 is sufficiently dry, the coating material of the coating layer 3 does not adhere to the second side coating backup roller 24. Meanwhile, the second side faces the second side coating die 23, and therefore the second side of the electrode foil 2 is coated. The electrode foil 2 coated on the second side is then conveyed in the direction of an arrow L in FIG. 2 to return to the fourth electrode conveyance section 70 in the interior of the drying oven 30.

Next, the electrode foil 2 is conveyed through the fourth electrode conveyance section 70 from the first oven end unit 20 to the second oven end unit 80, or in other words in the direction of the arrow M in FIG. 2. At this time, as shown in FIG. 6, the electrode foil 2 travels along the conveyance path 71 of the fourth electrode conveyance section 70.

Next, the electrode foil 2 reaches the location of the turn-back roller pair 86. At this time, the dry coating layer 3 on the first side contacts the turn-back roller pair 86. The advancement direction of the electrode foil 2 is inverted by the turn-back roller pair 86 such that the electrode foil 2 travels along the conveyance path 61 of the third electrode conveyance section 60, as shown in FIG. 5. The electrode foil 2 is then conveyed through the third electrode conveyance section 60 from the second oven end unit 80 to the first oven end unit 20, or in other words in the direction of the arrow N in FIG. 2.

Next, the foil 2 reaches the location of the turn-back roller pair 26, where the advancement direction thereof is inverted again. As a result, the electrode foil 2 is conveyed in the direction of the arrow M in FIG. 2 again, or in other words through the fourth electrode conveyance section 70 from the first oven end unit 20 to the second oven end unit 80. This time, however, the electrode foil 2 travels along the conveyance path 72 in FIG. 6.

The electrode foil 2 is then conveyed along the conveyance path 62 in FIG. 5, the conveyance path 73 in FIG. 6, the conveyance path 63 in FIG. 5, and the conveyance path 74 in FIG. 6 in that order. In other words, the coated electrode foil 2 reciprocates while being turned back by the turn-back roller pairs 26, 86, and thus the electrode foil 2 is conveyed through the second side drying unit 32 in an overall spiral shape.

Hence, in the electrode manufacturing apparatus 100 according to this embodiment, the first side of the electrode foil 2 is coated, whereupon the electrode foil 2 reciprocates through the drying oven 30 three times in the length direction. In an electrode manufacturing apparatus that does not convey the electrode foil in a spiral shape, as in this embodiment, the overall length of the drying oven is six times greater than that of the electrode manufacturing apparatus 100 according to this embodiment, assuming that the apparatus is operated at an identical conveyance speed, or in other words an identical production efficiency. Furthermore, in comparison with an electrode manufacturing device that does not convey the electrode foil in a spiral shape, the conveyance speed can be increased by a multiple of six in a case where the electrode foil is dried for an identical amount of time in a drying oven of an identical oven length. In other words, the production efficiency is improved by a multiple of six. The number of times the electrode foil 2 is turned back by the turn-back rollers, or in other words the number of times the electrode foil 2 wound back into a spiral shape, may be set as desired. Therefore, the production efficiency of the drying oven used in the electrode manufacturing apparatus 100 can be improved even further.

In the electrode manufacturing apparatus 100 according to this embodiment, the conveyance path of the electrode foil 2 conveyed during drying takes a spiral shape. Therefore, the oven length and the volume of the drying oven can be reduced. As a result, an electrode manufacturing apparatus that exhibits superior thermal efficiency and that can dry the coating layer 3 gradually over a sufficient drying period is realized. Furthermore, the first side coating die and second side coating die are both disposed in the first oven end unit 20, and therefore user operability is favorable. Hence, an electrode manufacturing apparatus exhibiting superior thermal efficiency and operability is realized.

Next, referring to FIG. 2, an electrode manufacturing method according to this embodiment will be described. First, the electrode foil 2 is fed along a conveyance path extending from the electrode foil reel 12 of the unwinding unit 10 to the electrode winding reel 92 of the winding unit 90 via the first oven end unit 20 and the drying oven 30. Next, the electrode winding reel 92 is driven by the motor. As a result, the electrode foil 2 is conveyed along the conveyance path.

Next, the first side of the electrode foil 2 is coated with the coating material by the first side coating die 21. At this time, tension is applied to the electrode foil 2, and therefore the electrode foil 2 is pressed against the backup roller 22. The first side coating die 21 applies the coating material to the first side of the electrode foil 2 in this state at the predetermined width and thickness.

The coating material applied at this time is a coating liquid obtained by mixing an active material, a binder, and so on. With the electrode manufacturing method according to this embodiment, a sufficient drying time can be secured, and therefore the electrode can be dried gradually. Hence, a reduction in peel strength does not occur.

Next, the electrode foil 2 with the coating material applied to the first side is conveyed to the first electrode conveyance section 40 of the drying oven 30. In the first side drying unit 31, warm air is blown from the air nozzles 33, thereby increasing the temperature of the electrode foil 2 and the coating layer 3 on the first side. As a result, moisture contained in the coating material is vaporized. Accordingly, the coating layer 3 on the first side gradually dries. The temperature and amount of warm air blown from the air nozzles 33 are adjusted to different values in each air nozzle so that the electrode foil 2 is dried gradually. As a result of the drying, the coating layer 3 on the first side is bound to the electrode foil 2. Moreover, the binder does not migrate during the drying process. The reason for this is that the coating material can be dried under appropriate drying conditions.

Next, the coating material is applied to the second side of the electrode foil 2 by the second side coating die 23. At this time, tension is applied to the electrode foil 2, and therefore the electrode foil 2 is pressed against the backup roller 24. Since the coating layer 3 on the first side is already dry, the coating material can contact the backup roller 24 without adhering to the backup roller 24. Moreover, the coating layer 3 does not peel away from the electrode foil 2. The second side coating die 23 applies the coating material to the second side of the electrode foil 2 in this state at the predetermined width and thickness. At this time, the second side coating die 23 applies the coating material to a directly opposite position to the first side.

Next, the electrode foil 2 with the coating material applied to the second side is conveyed to the fourth electrode conveyance section 70 of the drying oven 30. In the second side drying unit 32, warm air is blown from the air nozzles 33, thereby increasing the temperature of the electrode foil 2 and the coating layer 3 on the second side. As a result, moisture contained in the coating material is vaporized. Accordingly, the coating layer 3 on the second side gradually dries. The temperature and amount of warm air blown from the air nozzles 33 are adjusted to different values in each air nozzle so that the electrode foil 2 is dried gradually. As a result of the drying, the coating layer 3 on the second side is bound to the electrode foil 2. Moreover, the binder does not migrate during the drying process. The reason for this is that the coating material can be dried under appropriate drying conditions. During the drying, the temperature on the first side of the electrode foil 2 also rises. However, the first side of the electrode foil 2 is dried sufficiently before the coating material is applied to the second side, and therefore drying conditions such as moisture content are substantially identical on the first and second sides.

The electrode 1 with the coating layer 3 applied to both sides of the electrode foil 2 is then wound onto the electrode winding reel 92 of the winding unit 90. Thus, a roll-shaped lithium ion secondary battery electrode is manufacture. A lithium ion secondary battery can then be manufactured using the electrode manufactured in this manner by implementing processes such as winding, flattening, can insertion, and liquid injection.

The electrode manufacturing method according to this embodiment is employed by the electrode manufacturing apparatus 100 to apply the coating layer 3 to both sides of the electrode foil 2 and then dry the coating layers 3. Further, in the electrode manufacturing method according to this embodiment, the coating layer 3 is dried as the electrode foil 2 is conveyed through the interior of the drying oven 30 in a spiral shape such that the coating layer 3 faces the outer side of the spiral. Hence, an electrode manufacturing method with which the coating layer 3 can be dried gradually and sufficiently is realized.

For comparison, a case in which the coating material applied to the electrode foil 2 is dried rapidly will now be described. In this case, the binder may be distributed unevenly. In the interior of the coating layer 3 in a film thickness direction, the binder that exists near a boundary between the coating layer 3 and the electrode foil 2 may migrate to the vicinity of the surface of the coating layer 3 in the film thickness direction. This migration occurs due to convection and air bubbles caused by evaporation occurring in the interior region of the coating layer 3 in the film thickness direction. In an electrode 1 dried under these conditions, the binder migrates to the surface of the coating layer 3.

When the binder migrates in this manner, peel strength in the vicinity of the boundary with the electrode foil 2 in the interior of the coating layer 3 in the film thickness direction decreases. An electrode having reduced peel strength cannot withstand variation in the volume of the coating layer 3 due to lithium ion occlusion/emission occurring when the manufactured battery is used, and therefore the coating layer 3 may peel away from the electrode foil 2. As a result, a sufficient electrode reaction does not occur, and therefore a satisfactory battery performance cannot be obtained.

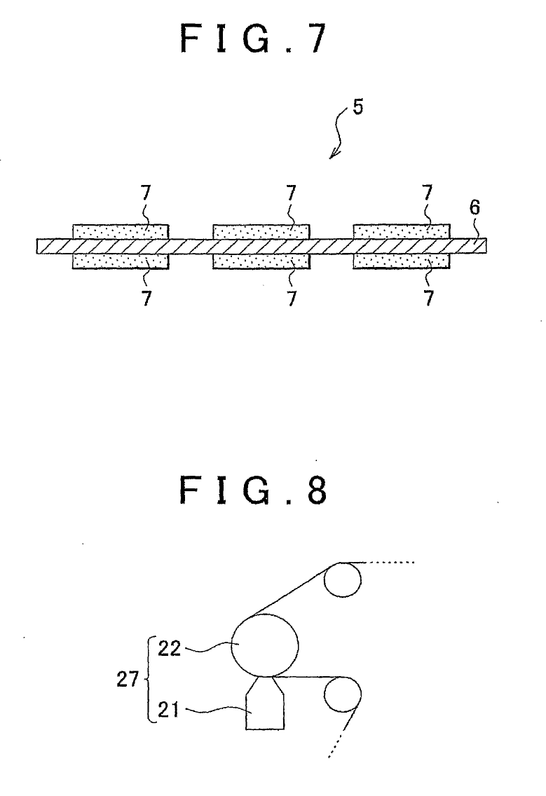

A modified example of this embodiment will now be described. As shown in FIG. 1, the electrode 1 manufactured by the electrode manufacturing apparatus 100 according to this embodiment is a single-coated electrode. However, two or more coating layers may be applied. As an example, FIG. 7 shows a triple-coated electrode 5. The electrode 5 is formed by applying a coating layer 7 to both sides of an electrode foil 6. In this case, the basic constitution of the electrode manufacturing apparatus 100 for manufacturing the electrode 5 is unchanged.

Further, in the electrode manufacturing apparatus 100 according to this embodiment, the turn-back roller pairs 25, 26, 85, 86 are disposed on the exterior of the drying oven 30, as shown in FIG. 2. However, if the turn-back roller pairs 25, 26, 85, 86 are made heat-resistant, they may be disposed in the interior of the drying oven 30. Further, a mechanism that makes minute adjustments to the width direction position of the electrode foil 2 during conveyance of the electrode foil 2 may be provided as appropriate. Alternatively, the turn-back roller pairs 25, 26, 85, 86 may be provided with this adjustment function. In this case, the turn-back roller pairs 25, 26, 85, 86 are constituted such that a central axis thereof can be inclined.

In the electrode manufacturing apparatus 100 according to this embodiment, the first side coating die 21 and second side coating die 23 are disposed horizontally, as shown in FIG. 2. However, the first side coating die 21 and second side coating die 23 may be disposed in positions for coating the electrode foil from the lower side thereof, as shown in FIG. 8, or disposed at an incline.

Further, in this embodiment, the driven rollers 34, 35 are disposed in the interior of the drying oven 30 in order to convey the electrode foil 2. However, instead of providing the driven rollers 34, 35, the air nozzles 33 may be disposed alternately above and below the conveyance path of the electrode foil 2 so that warm air is blown onto the electrode foil 2 from above and below. At this time, the warm air ejected from the air nozzles 33 disposed on the lower side of the electrode foil 2 causes the electrode foil 2 to float. The electrode foil 2 can be turned back during conveyance even when conveyed while floating in this manner.

Further, the air nozzles 33 are disposed in the interior of the drying oven 30 to dry the coating layer 3 in the drying oven 30. However, an infrared heater or another heater may be provided instead of, or in addition to, the air nozzles 33. In both cases, the coating layer 3 is dried by being heated. Further, the electrode foil reel 12 and the electrode winding reel 92 may be provided in pluralities. Moreover, a partition that separates the first electrode conveyance unit from the second electrode conveyance unit may be provided.

Furthermore, in this embodiment, the electrode foil 2 reciprocates three times through the interior of the first side drying unit 31 and three and a half times through the interior of the second side drying unit 32. However, the electrode foil 2 need only reciprocate through the interior of the drying oven 30 one and a half times. In this case, only two turn-back roller pairs need be provided in each drying unit. Further, the electrode foil 2 may reciprocate two or more times.

As described in detail above, the electrode manufacturing apparatus 100 according to this embodiment includes an inversion unit that modifies the advancement direction of the coated, wet electrode foil by turning the electrode foil back at an angle. As a result, the width direction position of the electrode foil is displaced such that the electrode foil can be conveyed through the interior of the drying oven 30 in a spiral shape. Hence, the oven length and the volume of the drying oven can be reduced. As a result, an electrode manufacturing apparatus that exhibits superior thermal efficiency is realized. Furthermore, the first side coating die and second side coating die are both disposed in the first oven end unit 20, and therefore operability is favorable. Hence, an electrode manufacturing apparatus exhibiting superior thermal efficiency and operability is realized.

Further, the electrode manufacturing method according to this embodiment is employed by the electrode manufacturing apparatus 100 to apply the coating layer 3 to both sides of the electrode foil 2 and then dry the coating layers 3. Moreover, in the electrode manufacturing method according to this embodiment, the coating layer 3 is dried as the electrode foil 2 is conveyed through the interior of the drying oven 30 in a spiral shape such that the coating layer 3 faces the outer side of the spiral. Hence, an electrode manufacturing method with which the electrode foil 2 remains in the drying oven 30 for a longer time such that the coating layer 3 can be dried gradually and sufficiently is realized.

Note that this embodiment is merely an example, and the invention is not limited thereto. Accordingly, the invention may be subjected to various improvements and amendments within a scope that does not depart from the spirit thereof. For example, the electrode manufactured by the electrode manufacturing apparatus 100 is not limited to a lithium ion secondary battery electrode. In other words, an electrode for use in another battery may be manufactured by the electrode manufacturing apparatus 100. Further, the second electrode conveyance section 50 may be provided above the first electrode conveyance section 40 without affecting the drying time. Moreover, the coating process performed by the electrode manufacturing apparatus may be applied to one side only. In this case, the die, backup roller and conveyance units for coating the second side are not required. Furthermore, the winding unit may be disposed in a downstream position of the first electrode conveyance unit.

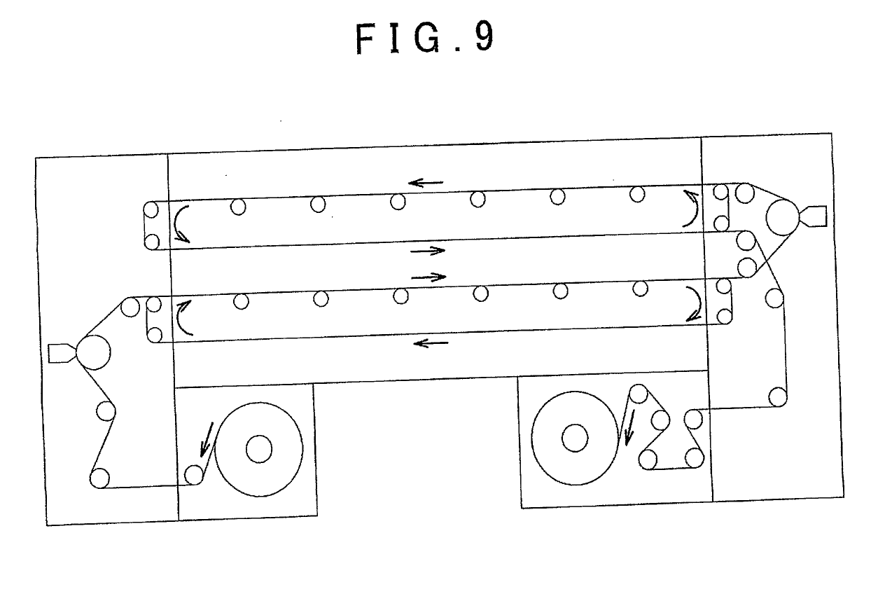

Further, the air nozzles 33 may blow warm air onto the electrode foil 2 in different amounts and at different temperatures according to the respective disposal locations thereof. The reason for this is that the coating layer 3 can still be dried under appropriate drying conditions in accordance with the temperature, moisture content, and so on of the coating material constituting the coating layer 3. Further, the first coating unit 27 and second coating unit 28 are disposed in the first oven end unit 20, but one or both of the first coating unit 27 and second coating unit 28 may be disposed in the second oven end unit. As an example, FIG. 9 is a sectional view showing a case in which the two coating units are disposed on either end of the drying oven. Furthermore, the inversion unit is not limited to a roller, as long as it inverts the advancement direction of the electrode foil 2.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. An electrode manufacturing apparatus comprising:
a coating unit that applies a coating material to a strip-form electrode foil;
a drying unit that dries a coating layer while conveying the electrode foil coated by the coating unit in a lengthwise direction thereof; and
at least two inversion units that invert an advancement direction of the electrode foil by contacting an opposite side of the electrode foil to the coating layer dried by the drying unit,
wherein the inversion units invert the advancement direction of the electrode foil, and displace a width direction position thereof by turning the electrode foil back such that the electrode foil is angled in a width direction thereof, and
wherein the drying unit dries the coating layer while the electrode foil reciprocates at least one and a half times as a result of inversion of the advancement direction of the electrode foil by the inversion units.

2. The electrode manufacturing apparatus according to claim 1, wherein:
the coating unit includes a first coating unit that coats a first side of the electrode foil and a second coating unit that coats a second side of the electrode foil;
the drying unit includes a first drying unit that dries the coating layer applied by the first coating unit and a second drying unit that dries the coating layer applied by the second coating unit;
the second coating unit coats the electrode foil following drying by the first drying unit; and
at least two of the inversion units are provided respectively in the first drying unit and the second drying unit.

3. The electrode manufacturing apparatus according to claim 2, wherein the first coating unit and the second coating unit are provided on an identical side relative to a reciprocating motion of the electrode through the first drying unit.

4. The electrode manufacturing apparatus according to claim 2, wherein the first coating unit and the second coating unit are provided on opposite sides relative to a reciprocating motion of the electrode through the first drying unit.

5. The electrode manufacturing apparatus according to claim 2, wherein:
the first coating unit includes a first side coating die and a first side coating backup roller; and
the second coating unit includes a second side coating die and a second side coating backup roller.

6. The electrode manufacturing apparatus according to claim 5, wherein a gap between the second side coating die and the second side coating backup roller is larger than a gap between the first side coating die and the first side coating backup roller by a thickness of the coating material applied to the first side.

7. The electrode manufacturing apparatus according to claim 2, wherein:
from a point at which the first coating unit finishes applying the coating material to the first side to a point at which the second coating unit applies the coating material to the second side, the electrode is conveyed such that the inversion units contact only the second side; and
from a point at which the second coating unit finishes applying the coating material to the second side, the electrode is conveyed such that the inversion units contact only the first side.

8. The electrode manufacturing apparatus according to claim 2, wherein the second coating unit applies the coating material to the second side after the first drying unit finishes drying the first side.

9. The electrode manufacturing apparatus according to claim 1, wherein the inversion units invert the advancement direction of the electrode such that the electrode does not contact the respective inversion units while undergoing a different process.

10. The electrode manufacturing apparatus according to claim 1, wherein:
the inversion units are respectively constituted by a set of two rollers; and
the angle can be modified by tilting a central axis of one of the rollers of the inversion unit such that the central axis is inclined in a horizontal plane relative to a central axis of the other roller.

11. An electrode manufacturing method comprising:
applying a coating material to a strip-form electrode foil and then drying a coating layer while conveying the electrode foil in a lengthwise direction,
wherein the coating layer is dried while an advancement direction of the electrode foil is modified at least twice such that the electrode foil reciprocates at least one and a half times as a result of inverting the advancement direction of the electrode foil while displacing a width direction position of the electrode foil during the drying by turning the electrode foil back such that the electrode foil is angled in a width direction thereof.
